(19) United States
(12) Patent Application Publication
(10) Pub. No.: US 2016/0210431 A1
(43) Pub. Date: Jul. 21, 2016

(54) Remote Technical Assistance for Surgical Procedures

(71) Applicant: Steven Sounyoung Yu, Fairfax, VA (US)

(72) Inventor: Steven Sounyoung Yu, Fairfax, VA (US)

(21) Appl. No.: 15/000,031

(22) Filed: Jan. 18, 2016

Related U.S. Application Data
(60) Provisional application No. 62/104,838, filed on Jan. 18, 2015.

(51) Int. Cl. G06F 19/00; H04L 29/08

(52) U.S. Cl. CPC G06F 19/3412; H04L 67/10

(57) ABSTRACT

Using telemedicine to give surgeons real-time intra-operative technical assistance from a remotely-located technical assistant on the use of a surgical product. An operating room (OR)-located computer system is in network communication with a remote-located computer system. The OR-located computer system has a display screen for displaying visual media that provides guidance about the use of the surgical product. A technical assistant at the remote assistance site can remotely control the presentation of the visual media.

### TECHNICAL FIELD

My invention relates to telemedicine, more particular, to telemedicine in surgery.

### BACKGROUND

Because of the complexity of many of today's medical devices, many surgeons and operating room staff rely on manufacturer's sales representatives to be onsite to provide assistance on how to use them. Often times, the sales representatives will use a laser pointer to point to different parts of the medical device and explain how to use them. Software and computer systems may be able to provide such assistance and eliminate the need for the sales representative to be onsite.

However, for the busy surgeon, learning how to navigate a new software interface is not a high priority. Moreover, it may be difficult or burdensome for the surgeon or staff person to operate and navigate the software interface in the middle of a surgical operation. The surgeon or staff person may even need to break out of the sterile field to use the software (e.g. via a mouse, keyboard, or touchscreen). My invention could be used by surgeons for receiving intra-operative real-time assistance from a remotely-located manufacturer's sales representative on the use of a surgical product.

### SUMMARY

My invention can be useful for providing remote assistance in the use of a surgical product in a surgical procedure. In one aspect, my invention is a method of performing a surgical procedure in an operating room (OR) with intra-operative guidance from a computer system. In one embodiment, the method comprises using a surgical product in performing the surgical procedure. The surgical product comprises multiple components.

In the operating room, there is an OR-located computer system comprising a display screen and having installed thereon an application software that is associated with the surgical product. The application software is configured to provide intra-operative guidance on the use of the surgical product by presenting visual media on the display screen. The method comprises using this OR-located computer system.

The OR-located computer system is in network communication with a remote-located computer system. The remote-located computer system is at a remote assistance site that is located remotely from the operating room. The remote assistance site is staffed with a technical assistant having technical knowledge about the surgical product.

The method further comprises intra-operatively communicating about the surgical product with the technical assistant via the OR-located computer system. The method further comprises receiving control of the application software by the remote-located computer system, which causes the OR-located computer system to display visual media providing guidance about the use of the surgical product.

The method further comprises viewing the visual media on the display screen. The method further comprises using the surgical product in the surgical procedure according to the guidance provided by the visual media.

In some embodiments, the visual media is pre-made and pre-stored as digital data. In some embodiments, the visual media includes audio content. In some embodiments, the application software provides a user interface to allow operating room personnel to directly operate the application software. In some embodiments, the intra-operative communication comprises video conferencing with the technical assistant via the OR-located computer system.

In some embodiments, at least some of the components of the surgical product are provided in a tray according to a predetermined layout; wherein the application software displays an image representing the layout of the components in the tray and is made to point out one or more components in the image of the tray under the control of the technical assistant; and the method further comprising selecting one or more components on the (physical) tray corresponding to the one or more components pointed out in the image of the (virtual) tray.

In another aspect, my invention is a method of providing assistance on the use of a surgical product to an operating room (OR) from a remote assistance site. In one embodiment, the method comprises marketing a surgical product that comprises multiple components. The surgical product is used in an operating room equipped with an OR-located computer system, which comprises a display screen and has installed thereon an application software that is associated with the surgical product. The application software provides intra-operative guidance on the use of the surgical product by presenting visual media on the display screen.

The method further comprises having at the remote assistance site, which is located remotely from the operating room, a remote-located computer system that is in network communication with the OR-located computer system. The method further comprises having at the remote assistance site, a technical assistant with technical knowledge about the surgical product. The method further comprises, at the remote assistance site, receiving communication from the operating room about the surgical product. The method further comprises, in response to the communication, remotely controlling the operation of the application software on the OR-located computer system to cause the OR-located computer system to display visual media providing guidance about the use of the surgical product.

In some embodiments, the surgical product is marketed under a specific identity and the components are specifically designated for use with at least that surgical product. In some embodiments, the visual media is made for a specifically identified surgical product.

In another aspect, my invention is a surgical system. In one embodiment, the surgical system comprises a surgical product that comprises multiple components. The system further comprises an application software that is associated with the surgical product and provides intra-operative guidance on the use of the surgical product by presenting visual media on the display screen of the computer system that is located in an operating room where the surgical product is being used. The application software is installed on the operating room (OR)-located computer system.

The system further comprises a remote-located computer system that is in network communication with the OR-located computer system. The remote-located computer system is located at a remote assistance site that is located remotely from the operating room. The remote assistance site is staffed with a technical assistant having technical knowledge about the surgical product.

In operation of the system, the remote-located computer system is capable of remotely controlling the operation of the application software on the OR-located computer system. The technical assistant receives a communication from the operating room about the surgical product, and in response to the communication, uses the remote-located computer system to control the operation of the application software on the OR-located computer system to cause the OR-located computer system to display visual media providing guidance about the use of the surgical product.

### BRIEF DESCRIPTION OF THE DRAWINGS

FIG. 1 shows an example of a computer system that could be used in my invention.

FIG. 2 shows an example of what could be displayed on the main display screen of the computer system.

FIG. 3 shows another example of what could be displayed on the main display screen of the computer system.

FIG. 4 shows the accessory screen of the computer system displaying a live video conference with a technical assistant.

FIG. 5 shows the technical assistant remotely taking control of the application software.

FIG. 6 shows the technical assistant pointing out components in the instrument tray by showing the particular component in a different color.

FIG. 7 shows the technical assistant using an arrow to point at the selected component.

FIG. 8 shows the technical assistant highlighting a fixation plate.

FIG. 9 shows the technical assistant further highlighting the set of screws that fit that particular fixation plate.

FIG. 10 shows the technical assistant highlighting the tools for implanting the fixation plate.

FIG. 11 shows the technical assistant initiating a short instructional video that explains how the various components fit together.

FIG. 12 shows the technical assistant pausing an instructional video and making a tele-illustration (telestration) on the video image.

### DETAILED DESCRIPTION

### Surgical Product

The surgical product can be any of the various types of surgical products that are used in a surgical procedure, which encompasses any of the various types of surgical operations or medical procedures that are performed on a patient's body. Examples of surgical procedures include abdominal surgery, gynecological surgery, chest or cardiac surgery, orthopedic surgery, spinal surgery, neurologic surgery, dermatologic surgery, cardiac catheterization, interventional radiology procedures, gastrointestinal endoscopy, intravascular interventions, pulmonary bronchoscopy, urologic surgery, vascular surgery, dental procedures, etc. Such surgical procedures may be performed by open, endoscopic, endovascular, robotic, or any other suitable access route.

The surgical product comprises multiple components that are intended to be used in combination to perform the surgical procedure. As used herein, the term “component” in the context of surgical products means the various types of equipment, instruments, tools, prosthesis, implants, hardware, parts, materials, and other supplies that are marketed specifically for use in combination with each other. In some embodiments, the surgical product is marketed under a specific identity (e.g. model number or commercial brand name) and the components are specifically designated for use with at least that surgical product.

The components of the surgical product may or may not be packaged together. For example, some components may be provided as a set inside a tray and other accessory components provided in sterile bags or boxes. In another example, each of the components may be packaged individually and sold separately, but are intended to be used together at the time of the surgical procedure.

For example, for an orthopedic surgical product, the components may include instruments (drills, saws, clamps, etc.), implants (fixation plates, joint replacements, prosthesis, etc.), or orthopedic hardware accessories (screws, pins, rods, drill bits, etc.). In another example, for an endoscopic surgical product, the components may include cameras, access ports, trocars, forceps, graspers, electrocautery probes, clip appliers, staplers, etc. In another example, for a robotic surgery apparatus, the components may include articulated wrist attachments, robot arms, access ports, endoscopes, etc. In another example, for an intravascular surgical product, the components may include catheters, balloons, guidewires, extension wires, introducer sheaths, or obturators. In another example, for a neurosurgery product, the components may include pulse generators, wires, electrodes, programming interfaces, etc. A specific example of a surgical product would be Medtronic's Model 3387 DBS (deep brain stimulation) lead kit, which includes a neurostimulation lead, stylets, torque wrench, screening cables, depth stop gauge, burr hole ring and cap, connector boot, tunneling rod, tunneling tip, tunneling tube, and lead cap.

Computer System.

At the operating room site, there is a computer system for providing assistance on the use of the surgical product. The computer system has a processor, memory, and display screen. The computer system further includes an audio speaker and audio microphone for audio communication between the operating room personnel and the remote technical assistant. In some embodiments, the computer system further comprises a video camera for visual communication between the operating room personnel and the remote technical assistant.

The computer system may further include input devices such as a keyboard, mouse, or touchscreen. The computer system is network-connected to a remote computer system located at a remote site. The computer system may be integrated or connected with other equipment in the operating room, such as endoscopes, x-ray fluoroscopes, microscopes, or patient monitors. As such, data (e.g. images) from such equipment can be transmitted by the computer system to the remote technical assistant.

As used herein, the term “operating room” means a room configured with equipment (such as lighting, operating table or chair, patient stretchers, patient monitoring devices, medical equipment carts, electrocautery machine, procedure trays, anesthesia or respiratory equipment, etc.) for performing a surgical procedure. The operating room may be within any of various types of medical facilities, including hospitals, doctor offices, outpatient surgical suites, or ambulatory surgery centers. The operating room may not necessarily be used exclusively for the purpose of performing surgical procedures. For example, a dental suite where both non-invasive dental examinations and dental procedures are performed would fall under the term “operating room” as used herein.

The term “operating room personnel” means those persons who work in the operating room to perform or assist in the surgical procedure. Such persons include the medical practitioner who is performing the surgical procedure (e.g. surgeon, cardiologist, interventional radiologist, gastroenterologist, etc.) as well as any anesthesiologists, nurses, physician assistants, surgical technicians, dental assistants, manufacturer representatives, and other medical specialty personnel.

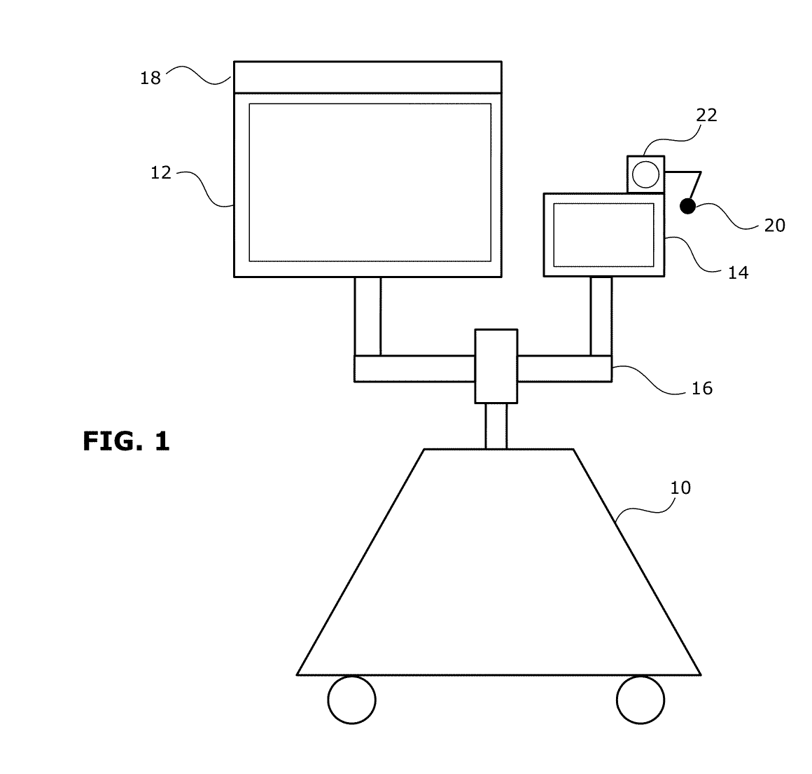

FIG. 1 shows an example of a computer system that can be used in my invention. The computer system includes a general purpose computer contained inside a cabinet and mobile platform 10 with wheels. There is a main display screen 12 and an accessory display screen 14, which are mounted on display arms 16 so that they can be adjusted for optimal viewing angles by the operating room personnel. Additional audio/visual communication capabilities are provided by the audio speaker 18, audio microphone 20, and video camera 22.

As explained below, the application software is capable of being controlled remotely. Because this may allow the operating room personnel to use the application software intra-operatively without having to touch any part of the computer system, in some embodiments, the computer system is outside the sterile surgical field. In some embodiments, no part of the computer system is within the sterile surgical field.

Application Software.

Installed on the computer system in the operating room is an application software that is associated with the surgical product and is designed to be used intra-operatively (i.e. while the surgical procedure is in progress) with the surgical product. The term “associated with” as used herein in this context means that the application software is made by or made under the direction of the same business entity (or affiliate thereof) that markets the surgical product and is designed specifically to at least encompass use with that particular surgical product. The application software may be capable of handling multiple different surgical products. For example, it may be capable of handling all of the multiple different surgical products of a particular medical device manufacturer's orthopedic product line.

The application software instructs the computer system, under the operation of a user, to display visual media on the display screen of the computer system. The visual media provides guidance about the use of the surgical product. For example, the visual media may show which components to use, how to prepare the components for use, how to calibrate the components, how the components fit together, how to assemble the components, how to navigate a component into the patient's body, how to insert or implant a component into the patient's body, how a particular component fits with another component, warnings, problems to avoid, how to handle problems, etc.

Visual Media.

The visual media shown in the display screen may be provided in any of a number of different forms, such as graphics, documents, instructional videos, animations, demonstrations, photos, images, text, illustrations, etc. The visual media may further include audio content (e.g. sound or voice recordings). In addition to the visual media itself, the visual content shown on the display screen may include live action elements such as a live video feed sent from the remote-located computer by the remote technical assistant or real-time manipulation of the visual media (e.g. pointing an arrow or drawing a circle on the visual media).

The visual media is pre-made and pre-stored as digital data, which may reside on the computer system itself (e.g. on its hard drive or optical drive) or stored elsewhere and accessible via the network. For example, the data for the visual media may be stored at the remote assistance site or at a third party site (e.g. hosted as a cloud service) and transmitted to the OR-located computer. The term “pre-made” means that the visual media is generated prior to the intra-operative assistance session. For example, the visual media may be an already-existing instruction manual or instructional video made by a medical device manufacturer on how to use or deploy their medical device product. In some embodiments, the visual media is made for a specifically identified surgical product (e.g. by model number or commercial brand name, such as Stryker's VARIAX™ plating system).

Remote Control.

The application software provides a user interface to allow operating room personnel to directly operate the application software (e.g. through a mouse, keyboard, or touchscreen to interact with a graphical user interface), including displaying of the visual media or controlling the presentation of the visual media (e.g. select and open content, zoom in, select from menu options, etc.).

Furthermore, the application software is designed such that its operation can also be controlled remotely through a network connection from a remote-located computer system. Through this remotely-controlled operation, the application software can be instructed to display the visual media. Any suitable hardware or software technology may be deployed for implementing remote control of the application software. Examples of hardware or software technologies that can be deployed to implement remote control of an application software are described extensively in the patent literature, such as US 2009/0300510 (to Gantman et al.), U.S. Pat. No. 8,589,800 (to Kominac et al.), U.S. Pat. No. 8,776,188 (to Manion et al.), U.S. Pat. No. 5,949,412 (to Huntsman), and U.S. Pat. No. 8,650,494 (to Sampath et al.). Examples of commercially-available solutions for remote control of an application software include TEAMVIEWER™ (which is advertised to provide remote control of any computer over the internet within seconds), LOGMEIN™ PRO sold by LogMeln, Inc., and BOMGAR™ hardware and software sold by Bomgar Corp.

There are numerous ways in which the technical assistant can control the application software in presenting the visual media. Some examples include selecting, initiating, starting, stopping, or pausing a video presentation; zooming in on a particular section of a graphical illustration, etc. In some cases, this could involve the technical assistant remotely adding graphical content to the visual media, such as displaying an arrow and pointing it at a part of a graphical illustration, making annotations within a document (e.g. drawing a circle), making freehand sketches onto a displayed image, highlighting a certain item in a displayed image, etc.

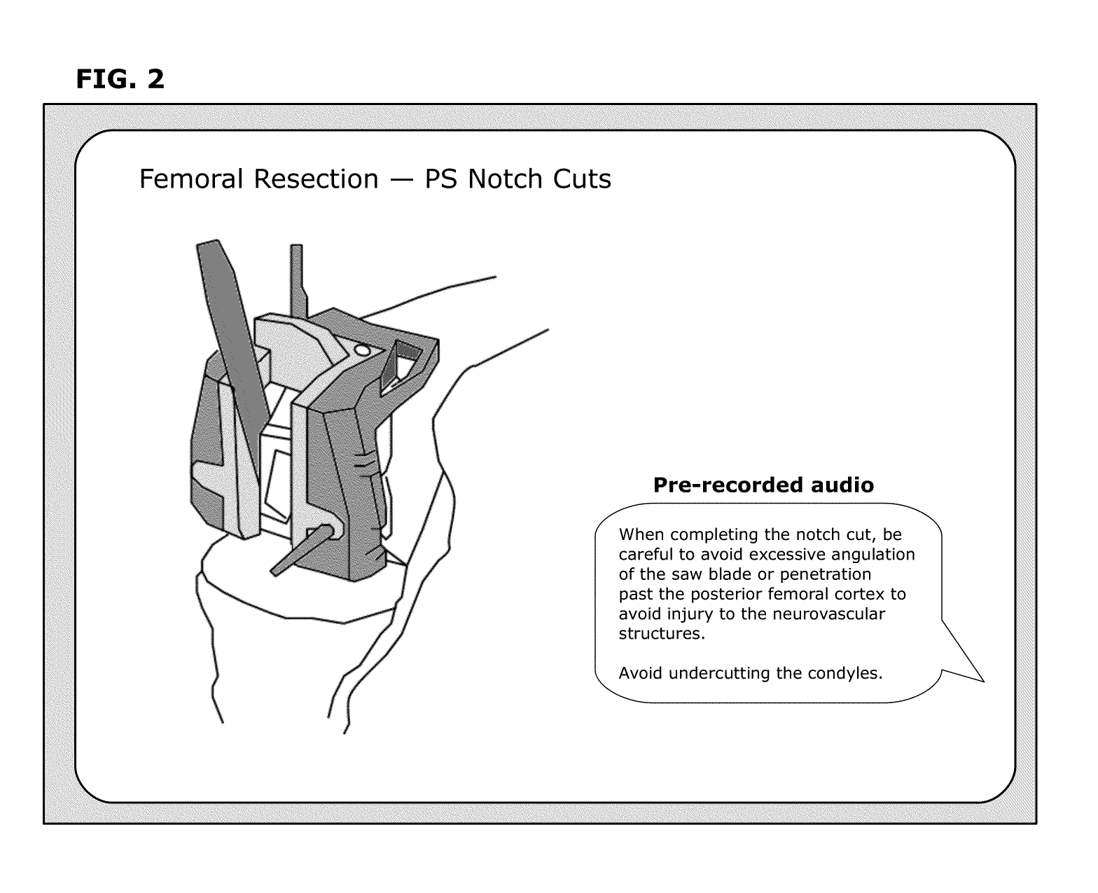

FIG. 2 shows an example of what might be displayed on the main display screen in the computer system of FIG. 1. In this example, the orthopedic surgeon is performing a knee replacement surgery using a particular knee replacement prosthesis. To help the surgeon with using a femoral resection notch guide in preparing the knee for the joint prosthesis, a technical assistant at the manufacturer's remote site has taken control of the application software and brought up a document that shows a graphical illustration of how the tool should be positioned and used. This illustration is accompanied by pre-recorded audio commentary giving some warnings about problems to avoid.

The computer system does not necessarily have to be exclusively in association with or tied to a particular surgical product vendor/manufacturer. For example, there may be multiple different applications software of my invention installed on the computer system (e.g. each application software being provided by a different vendor/manufacturer for their particular line of products). In another example, a single application software of my invention installed on a computer system may be able to handle surgical product lines from multiple different vendors/manufacturers.

Remote Assistance Site.

Assistance on the use of the surgical product is provided from a site that is remote from the operating room, i.e. being physically located in a different facility than where the operating room is located. In some embodiments, the remote site is located at least 2 miles distant from the operating room; in some cases, at least 5 miles distant (distance herein means straight-line distance). At the remote site, there is a technical assistant who has technical knowledge about the surgical product (e.g. a technician or sales representative that has experience with or has received training about how the surgical product is used). The technical assistant is not a surgical physician (i.e. not someone with medical school education and residency training in surgical practice).

The remote site is equipped with a computer system (remote-located computer system) that is in communication with the OR-located computer system through a network communication link, which can be any suitable type of network (such as Internet or local area network), and can use any suitable protocol (e.g. Internet Protocol, videotelephony, etc.), medium (e.g. fiber optic, coaxial cable, wireless broadband, etc.), network interface, or bandwidth. The remote-located computer system may be in communication with multiple OR-located computer systems. The remote site may have multiple different remote-located computer systems that are in communication with multiple different OR-located computer systems.

Virtual Representation of Tray.

In some embodiments, the surgical product is provided in a tray containing some or all of the multiple components of the surgical product. The components have a predetermined layout within the tray. In some cases, the visual media provided by the application software comprises an image that is a virtual representation of the tray with the “virtual” components arranged in the same layout as the actual (physical) tray.

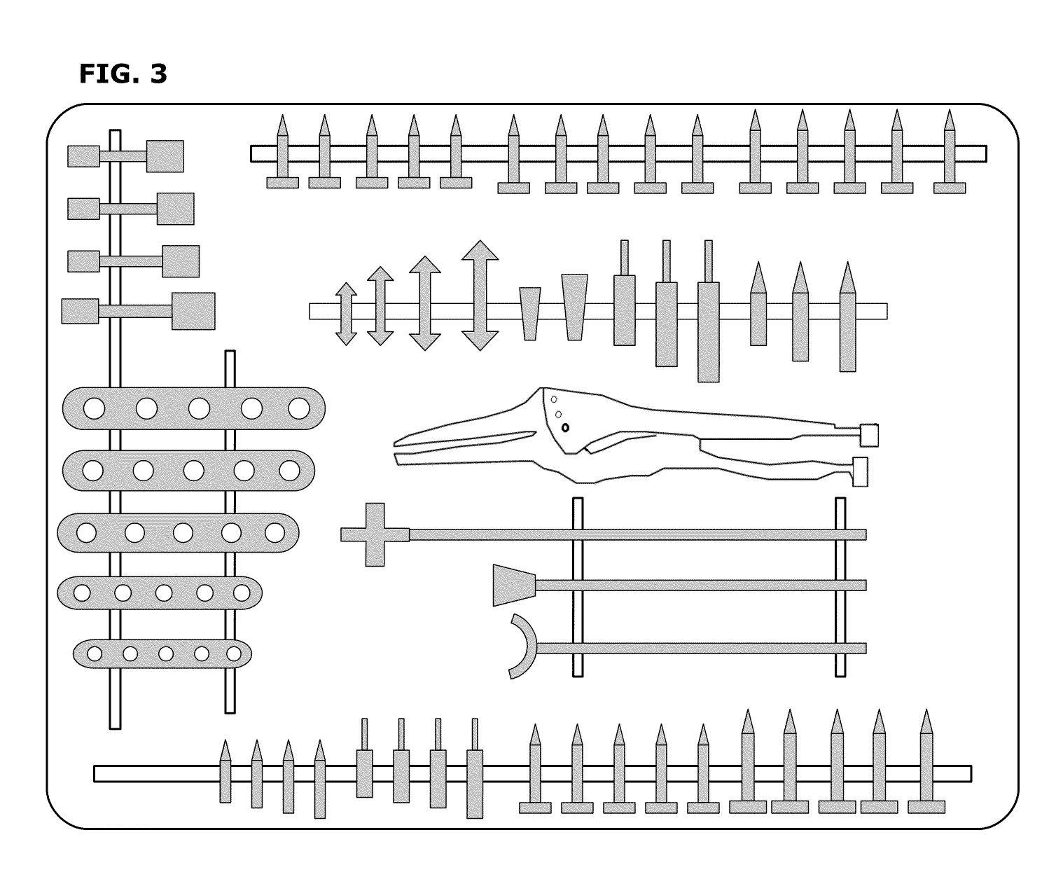

FIG. 3 shows an example of what might be displayed on the main display screen in the computer system of FIG. 1. In this scenario, the surgeon is using an orthopedic implant set, which comes provided in an instrument tray with the components laid out in a predetermined arrangement. Shown here is a virtual representation of that instrument tray containing the “virtual” orthopedic implant set as displayed on the computer display screen. The surgeon has already selected a particular fixation plate to use and wants to know where the screws fitting the selected fixation plate are located in the instrument tray.

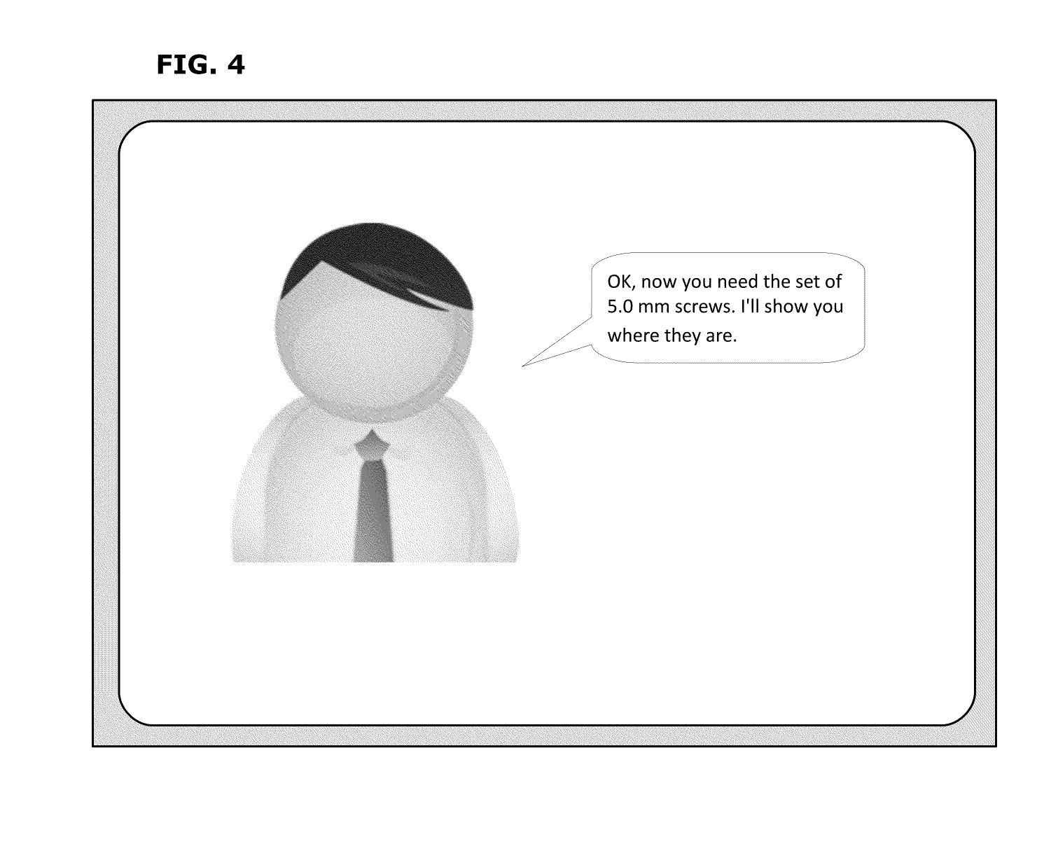

The surgeon interacts with the technical assistant via bi-directional audio/video through the audio/visual equipment on the computer system. As shown in FIG. 4, the accessory screen of the computer system displays a live video conference with the technical assistant who explains the type of screw that is required and offers to show its location in the instrument tray. The computer system does not necessarily need an accessory display. For example, the live video conference feed can be shown in a split-screen window on the main display of the computer system.

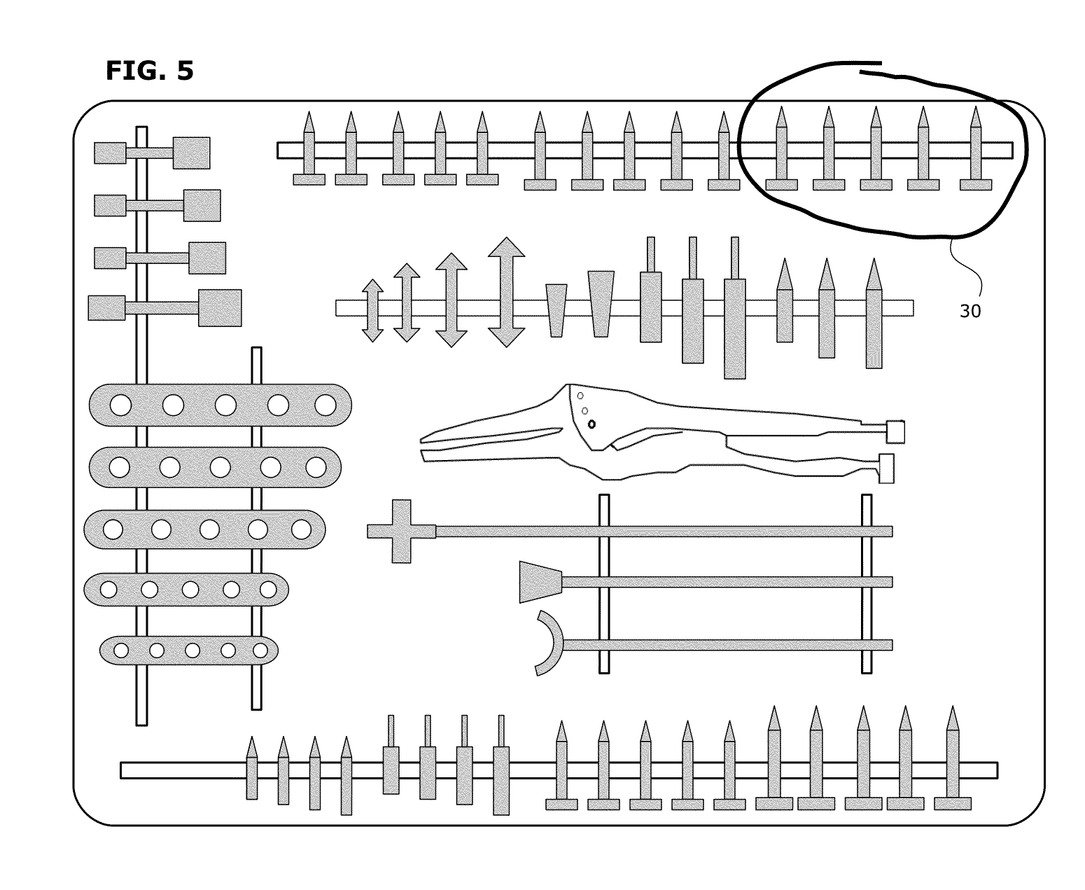

As shown in FIG. 5, the technical assistant has remotely taken control of the application software, and as shown on the main display screen, has drawn a circle 30 around the appropriate set of screws to indicate where they can be found on the instrument tray. Thus, the surgeon (or the OR assistant) can quickly locate the appropriate set of screws in the physical instrument tray.

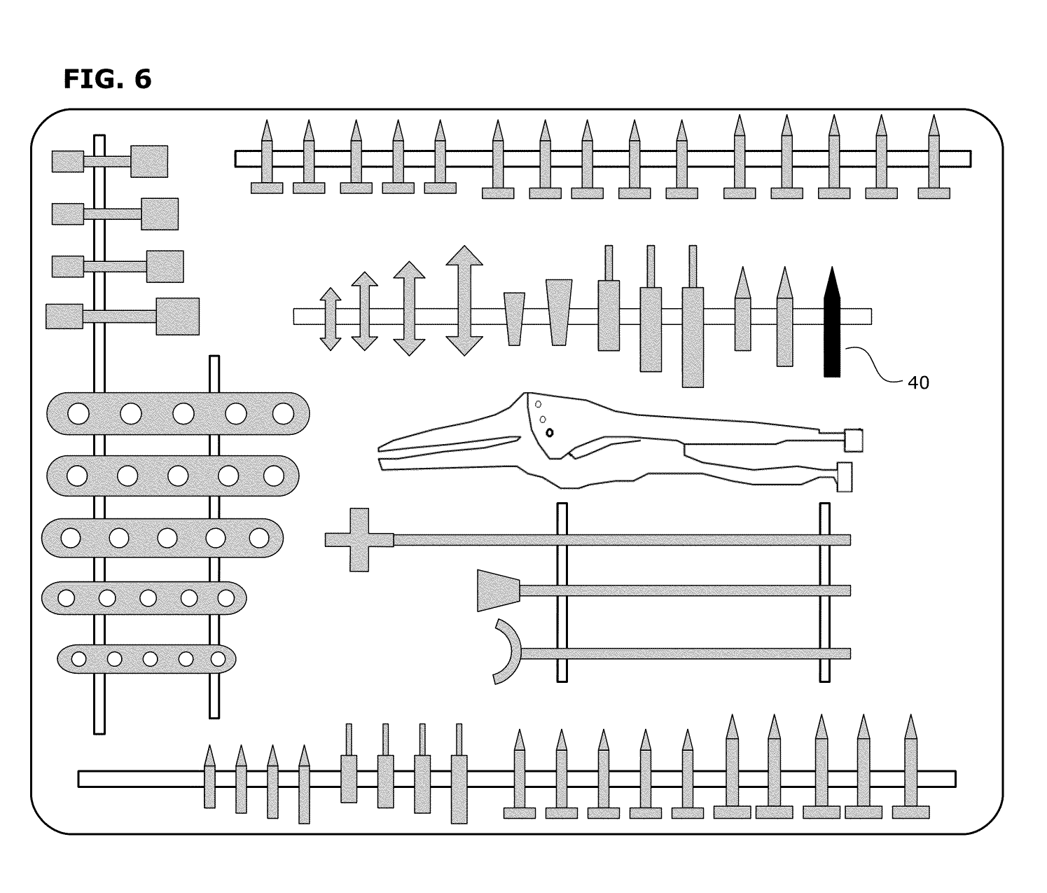

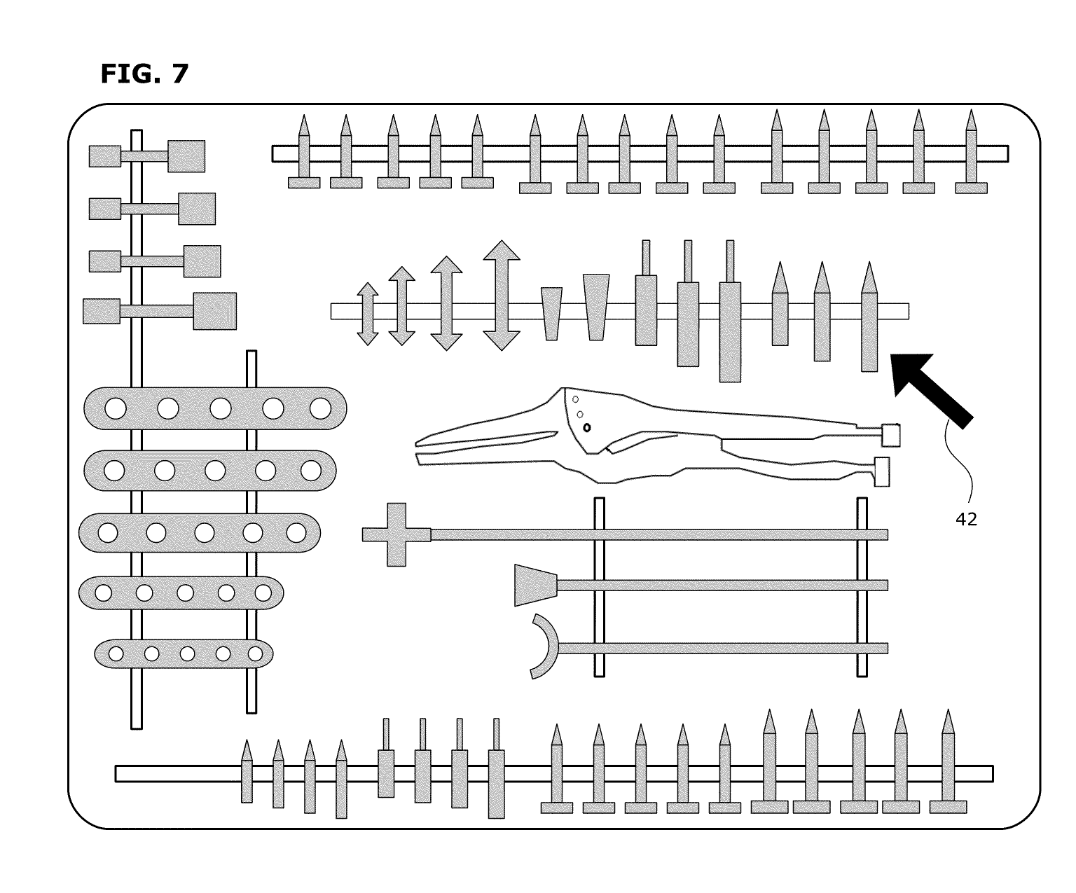

As shown in FIG. 6, the technical assistant can also point out components in the instrument tray by showing the particular component 40 in a different color (than the other components). In FIG. 7, the technical assistant uses an arrow 42 to point at the selected component. There are numerous other ways in which the technical assistant can point out a particular component, such as by flashing, animation, etc.

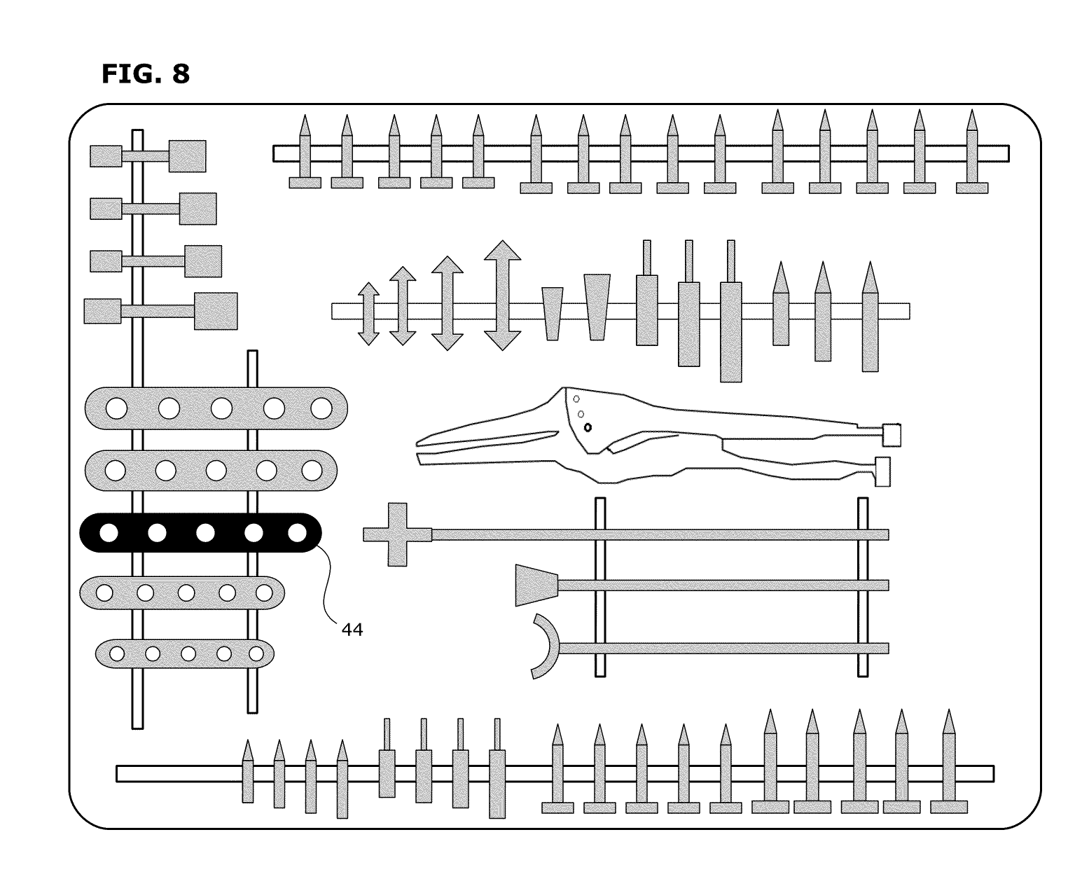

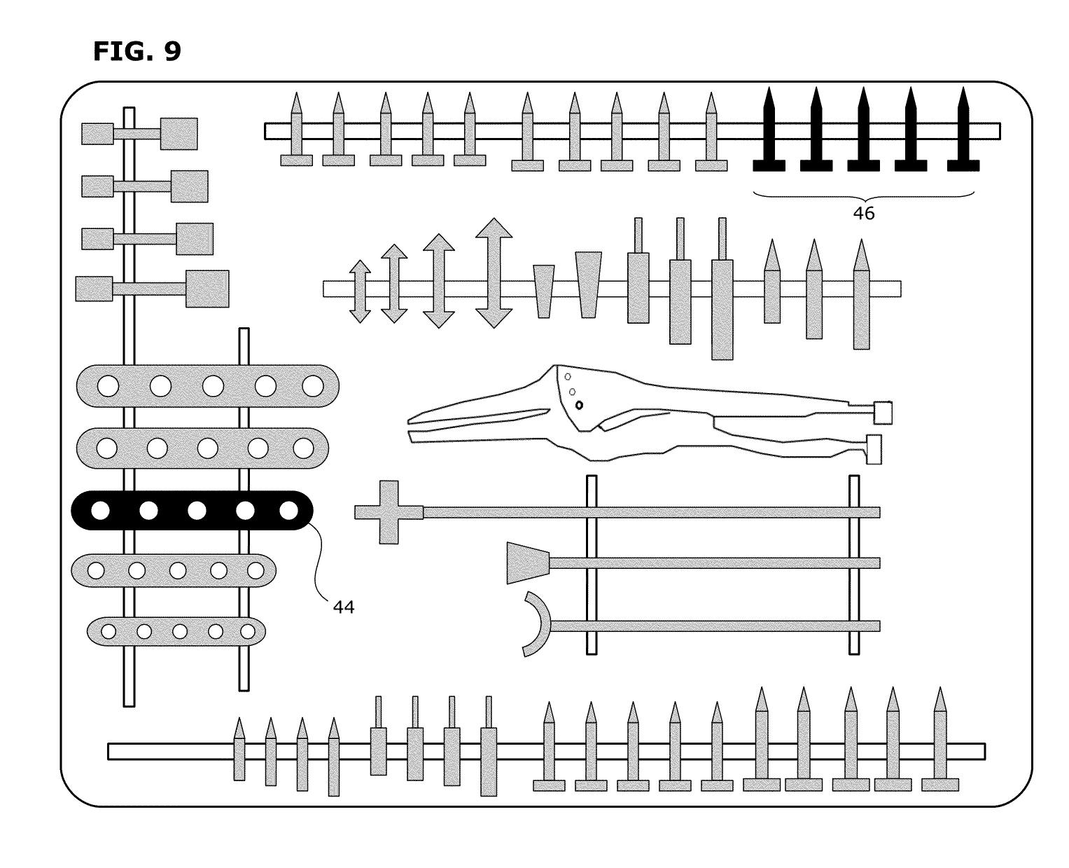

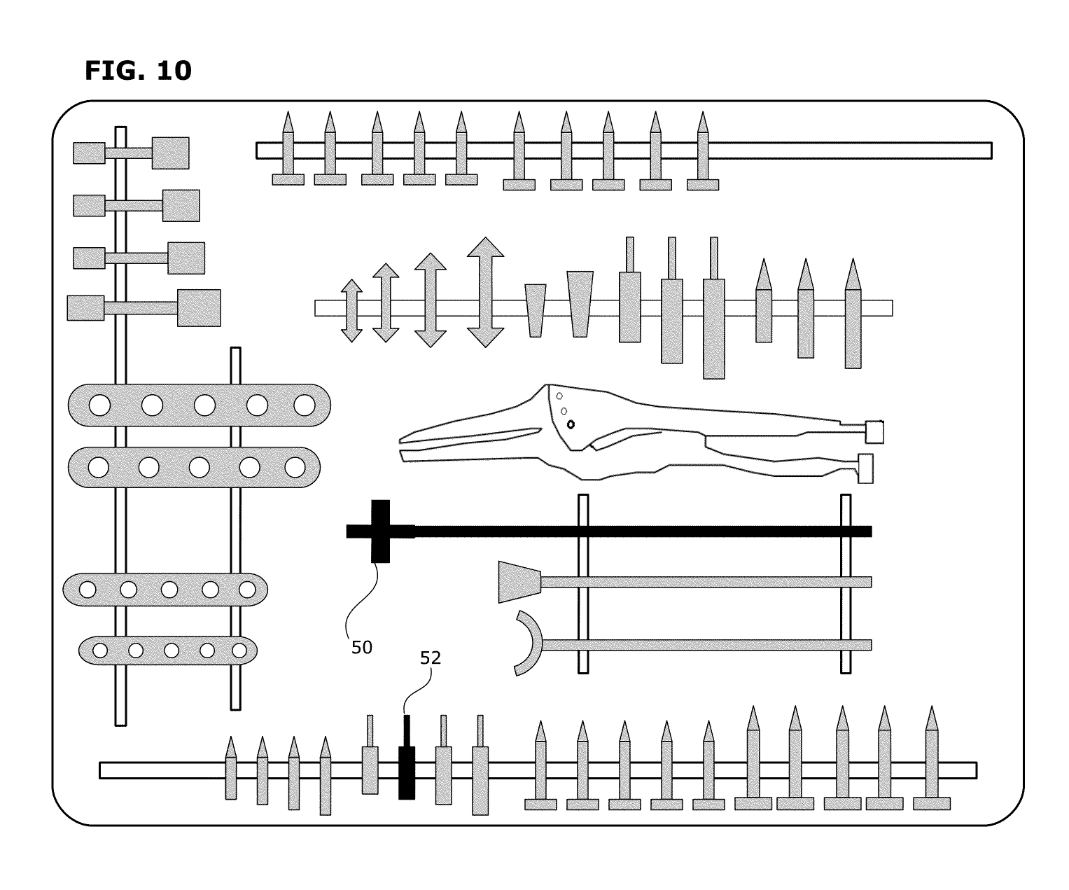

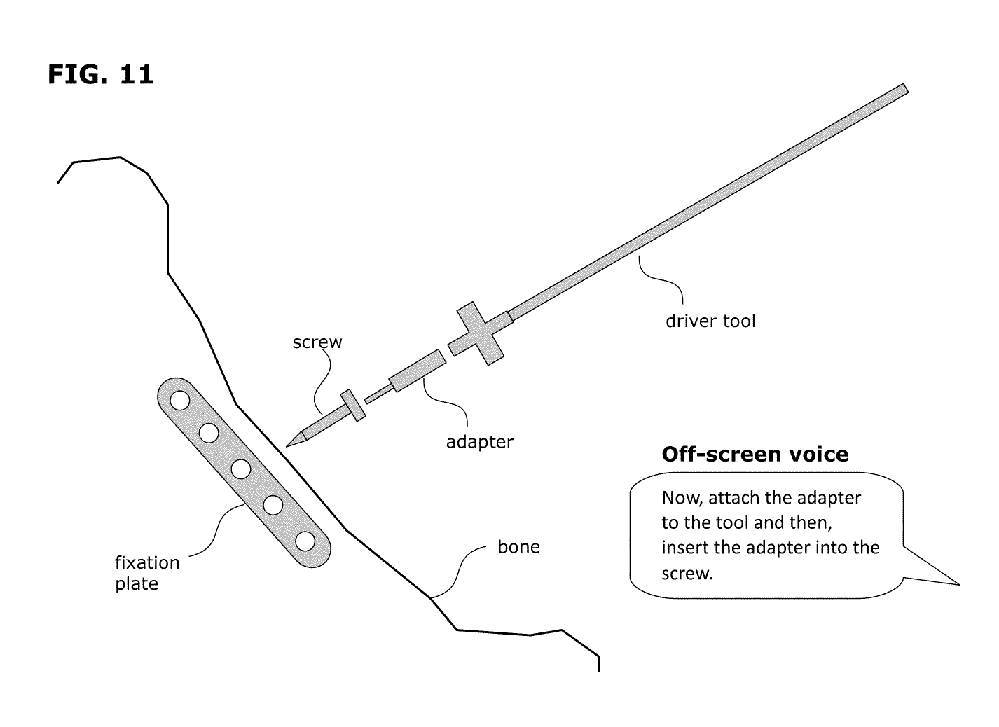

FIGS. 8-11 show how the technical assistant can give even more guidance about using the surgical product. As shown in FIG. 8, after having a dialogue with the surgeon (e.g. about the location and measurements made on the target bone site), the technical assistant highlights the appropriately-sized fixation plate 44 to use by showing it in a different color. As shown in FIG. 9, the technical assistant then further highlights the set of screws 46 that fit that particular fixation plate. As shown in FIG. 10, the technical assistant then highlights the tools 50 and 52 for implanting the fixation plate. As shown in FIG. 11, the technical assistant then initiates a short instructional video that explains how the various components fit together and operate to implant the fixation plate onto the bone. The technical assistant also makes some comments through the live audio feed.

Media Control and Telestration.

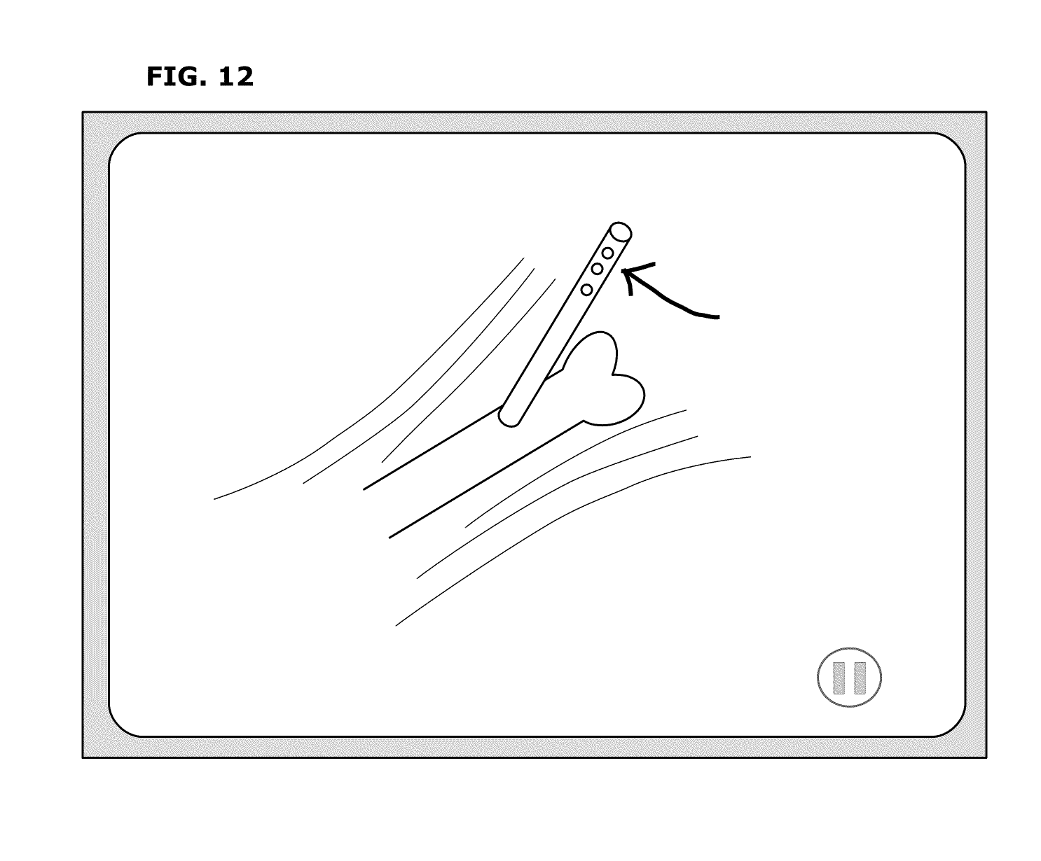

FIG. 12 shows an example of how the remotely-located technical assistant can use remote control of the visual media and telestration to intra-operative help a surgeon with a medical device in real time while performing a surgery. Shown here is a view of the display screen of the computer system located in the operating room. The visual media is a pre-made video showing how the medical device is used for implanting into a bone (e.g. this could be an instructional video made by the medical device manufacturer). The pre-made video (data) is stored on a remote computer system that is in network connection with the OR-located computer system.

In this example scenario, the surgeon has asked a question to the technical assistant about the medical device. In response, the technical assistant has controlled the OR-located computer system to load a relevant video from a library, fast-forward it, and then pause it at the relevant part of the video to answer the physician's question. In addition, the technical assistant has drawn a freehand sketched arrow on the paused video image to point to a particular part of the medical device to help answer the surgeon's question.

Surgical Method.

The operating room personnel uses the surgical product for performing the surgical procedure. In the course of performing the surgical procedure, the operating room personnel may seek guidance about the use the surgical product. The operating room personnel communicates with the remote technical assistant (e.g. by calling via the audio/visual link through the computer system). In response, the remote technical assistant may use the remote-located computer system to take control of the operation of the application software on the OR-located computer system and cause the application software to display particular visual media that is relevant to the guidance sought.

For example, in using a balloon angioplasty device, there may be a question about which type of balloon catheter to use. The operating room personnel uses the OR-located computer system to transmit a digital angiogram image of the target artery to the technical assistant. In response, the technical assistant may then answer the question verbally about which type of balloon to use. The technical assistant then remotely controls the application software to initiate a short instructional video on how to use the particular balloon catheter.

In another example, in performing a single-port laparoscopic cholecystectomy, the surgeon may be having difficulty manipulating a laparoscopic tool through the access port. The surgeon may ask the remote technical assistant about how to adjust the access port to obtain better range of motion for the laparoscopic tool. Further, the laparoscope camera or video system may be connected to the OR-located computer system so that it can transmit live video or still images from the laparoscope to the technical assistant. Also, the computer system's video camera can be aimed at the surgical field or the access port to give the remote technical assistant a visual view of the situation.

After hearing the surgeon describe the problem and viewing the transmitted images, the technical assistant can then take control of the application software to bring up a graphical image (pre-made) of the access port and use an arrow pointer to show how the access port can be adjusted to obtain a better range of motion to reach a particular anatomical target.

The foregoing description and examples have been set forth merely to illustrate my invention and are not intended to be limiting. Each of the disclosed aspects and embodiments of my invention may be considered individually or in combination with other aspects, embodiments, and variations of my invention. In addition, unless otherwise specified, the steps of the methods of my invention are not confined to any particular order of performance. Modifications of the disclosed embodiments incorporating the spirit and substance of my invention may occur to persons skilled in the art, and such modifications are within the scope of my invention.

Any use of the word “or” herein is intended to be inclusive and is equivalent to the expression “and/or,” unless the context clearly dictates otherwise. As such, for example, the expression “A or B” means A, or B, or both A and B. Similarly, for example, the expression “A, B, or C” means A, or B, or C, or any combination thereof.

I claim:

1. A method of providing assistance on the use of a surgical product that is being used in an operating room, wherein the operating room is equipped with an OR-located computer system comprising a display screen, the method comprising:
having installed on the operating room (OR)-located computer system an application software that is associated with the surgical product, the application software being configured to provide intra-operative guidance on the use of the surgical product by presenting visual media on the display screen;
having at a remote assistance site that is located remotely from the operating room, a remote-located computer system that is in network communication with the OR-located computer system;
having at the remote assistance site, a technical assistant with technical knowledge about the surgical product;
at the remote assistance site, receiving communication from the operating room about the surgical product;
in response to the communication, remotely controlling the operation of the application software on the OR-located computer system to cause the OR-located computer system to display visual media providing guidance about the use of the surgical product.

2. The method of claim 1, wherein the application software is configured to allow remote control of the application software from the remote-located computer, and wherein the remote-located computer is programmed to take remote control of the application software.

3. The method of claim 1, wherein the step of remotely controlling the operation of the application software comprises the technical assistant remotely controlling the presentation of the visual media.

4. The method of claim 3, wherein the step of remotely controlling the presentation of the visual media comprises the technical assistant adding graphical content to the visual media that is being presented.

5. The method of claim 1, wherein the visual media is pre-made and pre-stored as digital data.

6. The method of claim 1, wherein the visual media includes audio content.

7. The method of claim 1, wherein the application software is configured to provide a user interface that allows operating room personnel to directly operate the application software.

8. The method of claim 7, wherein the user interface allows operating room personnel to control the presentation of the visual media.

9. The method of claim 4, wherein the application software is configured to provide a user interface that allows operating room personnel to directly operate the application software; and wherein the user interface allows operating room personnel to control the presentation of the visual media.

10. The method of claim 1, wherein the intra-operative communication comprises video conferencing with the technical assistant via the OR-located computer system.

11. The method of claim 1, wherein at least some of the components of the surgical product are provided in a tray according to a predetermined layout.

12. The method of claim 11, wherein the visual media includes an image representing the layout of the components in the tray.

13. The method of claim 1, further comprising marketing the surgical product comprising multiple components.

14. The method of claim 13, wherein the surgical product is marketed under a specific identity and the components are specifically designated for use with at least that surgical product.

15. The method of claim 14, wherein the visual media is made for the specifically identified surgical product.

16. The method of claim 1, wherein the OR-located computer system is outside the sterile surgical field.

17. The method of claim 1, wherein no part of the OR-located computer system is within the sterile surgical field.

18. The method of claim 1, wherein the remote assistance site is located at least 2 miles distant from the operating room.

19. The method of claim 16, wherein the application software is configured to provide a user interface that allows operating room personnel to directly operate the application software, and wherein the user interface allows operating room personnel to control the presentation of the visual media.

20. A surgical system comprising:
a surgical product comprising multiple components;
at an operating room site where the surgical product is being used, an application software that is installed on an operating room (OR)-located computer system that comprises a display screen, wherein the application software is associated with the surgical product and provides intra-operative guidance on the use of the surgical product by presenting visual media on the display screen;
at a remote assistance site that is located remotely from the operating room, a remote-located computer system that is in network communication with the OR-located computer system, the remote assistance site being staffed with a technical assistant having technical knowledge about the surgical product;
wherein the remote-located computer system is capable of remotely controlling the operation of the application software on the OR-located computer system;
wherein the technical assistant receives a communication from the operating room about the surgical product, and in response to the communication, uses the remote-located computer system to control the operation of the application software on the OR-located computer system to cause the OR-located computer system to display visual media providing guidance about the use of the surgical product.
